(19) United States
(12) Patent Application Publication
(10) Pub. No.: US 2009/0180149 A1
(43) Pub. Date: Jul. 16, 2009

(54) GRAPHIC DESIGN ENGINE FOR CUSTOM DESIGN OF LARGE FORMAT HIGH-RESOLUTION DIGITAL OUTPUT FILES

(75) Inventors: Jonathan Drake, Carmel Highlands, CA (US); Scott Larson, Del Rey Oaks, CA (US)

Correspondence Address: Beyer Law Group LLP, P.O. BOX 1687, Cupertino, CA, 95015-1687, US

(73) Assignee: FRESCO TECHNOLOGIES, INC., Monterey, CA (US)

(21) Appl. No.: 12/013,233

(22) Filed: Jan. 11, 2008

(51) Int. Cl. G06K 15/00

(52) U.S. Cl. 358/2.1

(57) ABSTRACT

A computer-implemented service is provided to generate a high-resolution digital image data file suitable for creating a large format item in which the digital image is imbued in an object. A user interacts with a configuration application program to determine configuration parameters for the high-resolution digital image data file. A representation (such as a low-resolution image) is displayed, to the user, of what would result if a high-resolution digital representation of an actual scene is adjusted in view of the at least one configuration parameter. Once the user has completed determination of the configuration parameters, the high-resolution digital image data file is generated from digital image data that is the high-resolution digital representation of an actual scene, adjusted in view of the at least one configuration parameter.

### BACKGROUND

The present invention relates generally to a network-based service to flexibly generate a high resolution digital image file through the use of an on-line design engine that allows a user to easily configure custom files suitable for high resolution, large format digital output.

According to the Specialty Graphic Imaging Association, business in the area of using digital graphics is thought to be growing revenue on the order of $1 billion a year, steadily over at least the past eight years. In many cases, digital graphics are used in “short term” applications for display, advertising, special event applications, flags, banners, and trade show exhibits, or for inexpensive retail products such as T-shirts, coffee mugs and so forth. Such graphics generally do not need to meet exacting color standards or high quality graphic resolution standards.

A system for generating high quality digital output has been developed for reproducing fine art. A high resolution digital capture of the original artwork is created using a digital camera or a film photograph and then the digital image is printed directly to canvas, water color paper or other art media. These reproductions, sometimes termed Giclee reproductions, can be very true to the original and, while they may have good resistance to ultra violet light rays, they are otherwise generally quite fragile.

Recently, digital graphics have begun to be used in the architectural and semi-permanent display and exhibit market. This market includes, for example, wallpaper and wall treatments, textiles, curtains and upholstery, window treatments, surfaces, counter tops, table tops, architectural panels, display and decorative panels, flooring and ceiling. These applications are generally designed for longer range installation and the substrates and material platforms into which the digital decoration is rendered can be costly, even without the digital graphic embellishment. Therefore, it is generally desired that digital graphics in the architectural and permanent exhibit market meet very high quality graphic standards of the best off-set analog printing methods. It should also be noted that these architectural and permanent exhibit applications generally use large format graphics, often up to 48″×96″ and even larger.

Conventionally, there exist online libraries of small format, high resolution photographs. These files are of “ordinary scale” and can be purchased and downloaded for reproduction. For example, generally, the output from these files does not exceed 12″×18″ at high resolution. Such photo libraries are not particularly useful for the output that would generally be used in large format architectural and exhibit installations.

Creating a large format digital file suitable for reproduction in large format (e.g., 48″×96″ inches or larger) at high resolution (e.g., 150 dots per inch [dpi] or greater) is not a trivial task. Generally, source material (or some actual scene) is secured that is at least 24″×24″. This material is then photographed at full size such as with a large format film camera (4″×5″ transparency or greater) or a digital capture is made using a high resolution digital camera, such as a 384 mega pixel Betterlight, Super 8 K camera that can capture a 370 megabyte file or greater.

For example, if the image is captured on film, then the film may be digitally scanned at high resolution and rendered into a digital file for digital printing output. Once a digital file is created at high resolution, some files need to be manipulated into a full size 48″×96″ inch file without much loss of visual resolution. The image generally cannot be simply “blown up” by 600% to 48″×96″ without severe degradation in the output quality. The digital information on the file is generally simply not robust enough to achieve a satisfactory outcome when blown up 600%, at least not to meet the graphics quality standards expected from the architectural and exhibit markets, where costly and long range installations are common.

A qualified graphic artist/technician, using computer software such as Adobe PhotoShop or other graphics production software, may be able to manipulate the 300 dpi digital graphic through processes such as stepping, flipping, repeating, and stitching, to assemble a full size file of a given pattern—stone, wood, textile, and so forth or graphic element, or graphic repeat. The graphic assembly of large format files from smaller format files generally requires training and experience, as well as specialized equipment.

Manufacturers of digital output equipment, such as Epson, Kodak, VuTek, Arizona, Mimaki, Roland, Mutoh and others have been aggressively investing in developing printing machines to output higher quality images at faster speeds. This has resulted in significant improvements in both economics and the possible quality of digital graphic output. Digital printing equipment is quickly reaching a threshold that now enables the use of digital graphics in the architectural and exhibit markets where costly and longer range decorative and graphic installations are desired.

Nevertheless, the input—high resolution, large format digital files—remain complicated and expensive to generate. The digital graphics business model is built on the concept of quick turns, extreme customization and variation, with short runs and small quantities. This is not economically accomplished with analog printing methods where front-end costs utilize longer print runs in order to amortize the graphic development and set up costs. The expense and complexity of developing a high resolution large format digital file can defeat the advantages and elegance of the digital graphic printing business model, especially in the architectural and exhibit markets, where a job might require only a few 48″×96″ sheets of material.

Today, most architects, designers and specifiers have little capability to generate a high resolution, large format digital graphic file. High quality digital photo studios are expensive to set up and are not common. Graphics technicians, familiar with assembling high resolution large format digital files, are rare. Today a team of graphic designers and studio technicians generally collaborate with the architects and interior designers, not to mention the customer, in order to successfully develop a large format, high resolution digital file suitable for printing materials for use in the architectural and exhibit markets. This collaboration and coordination can be costly and can interfere with the vision of the customer for an ideal outcome.

### SUMMARY

A computer-implemented service is provided to generate a high-resolution digital image data file suitable for creating a large format item in which the digital image is imbued in an object. A user interacts with a configuration application program to determine configuration parameters for the high-resolution digital image data file. A representation (such as a low-resolution representation) is displayed, to the user, of what would result if a high-resolution digital representation of an actual scene is adjusted in view of the at least one configuration parameter. Once the user has completed determination of the configuration parameters, the high-resolution digital image data file is generated from digital image data that is the high-resolution digital representation of an actual scene, adjusted in view of the at least one configuration parameter.

### BRIEF DESCRIPTION OF THE DRAWINGS

FIG. 1 is an example architecture of a system in which a service may operate for users to conveniently customize large format digital image files.

FIG. 2 schematically illustrates an example of a user interface of a configuration application such as the configuration application shown in the FIG. 1 system.

FIG. 3 illustrates, in greater detail, an example of a base color definition portion of a user interface of a configuration application.

FIG. 4 illustrates, in greater detail, an example of a texture portion of a user interface of a configuration application.

FIG. 5 illustrates examples of a geometric pattern portion and a pattern color portion of a user interface of a configuration application.

FIG. 6 schematically illustrates an example user interface to an ordering engine.

FIG. 7 is a flowchart illustrating a process to utilize a system, such as the system or systems to achieve an adjusted high-resolution digital representation of an actual scene.

FIG. 8 is a simplified diagram of a network environment in which specific embodiments of the present invention may be implemented.

### DETAILED DESCRIPTION

The inventors have realized the desirability of providing a service via which users can conveniently customize large format digital image files. Using the service, the user interacts with an image (such as a low-resolution image) corresponding to a high-resolution digital representation of an actual scene, to adjust the image in view of configuration parameters provided by the user. The high-resolution digital representation of the scene is adjusted in view of the user-provided configuration parameters.

For example, the service may include an internet-accessible design engine that allows even an untrained user to configure generation of large format, high resolution digital files suitable for high resolution, large format output. The service breaks down constraints related to large format, high resolution graphic file generation, expanding the use of digital graphics in industries such as the architectural and exhibit industries, as well as in other industries.

In general, high resolution may mean at least 300 dots per inch (dpi) or, more generally, 100 dpi or greater. On the other hand, low resolution may mean less than 75 dpi. Furthermore, large format may mean 4 feet by 8 feet or, more generally, having dimension equal to or great than two feet on each side.

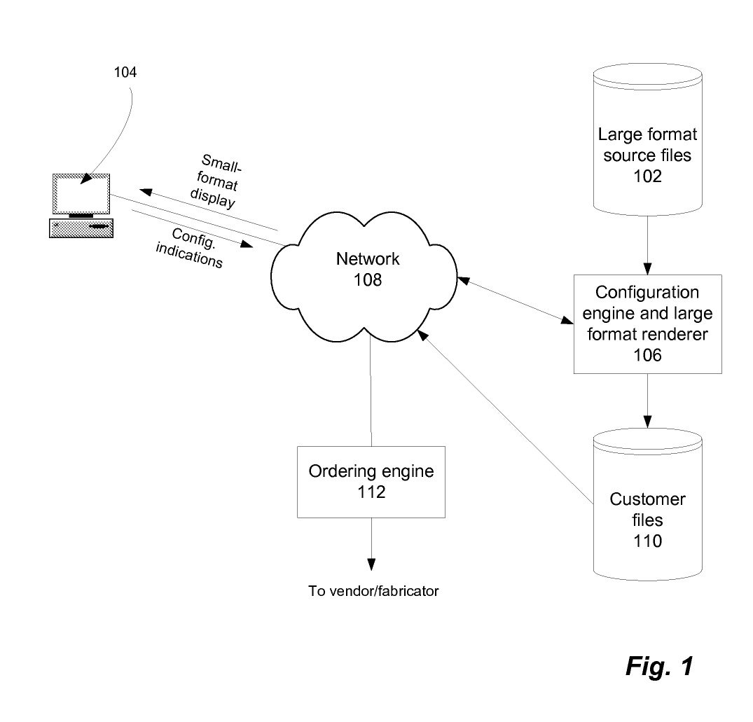

FIG. 1 is an example architecture of a system 100 in which such a service may operate. A data store 102 holds data files that are high-resolution digital representations of actual scenes. (While in FIG. 1 the data store 102 is shown as being coupled to a configuration engine 106, discussed later, one or more data files may be provided by a user.) That is, the ultimate source of the data in such a data file is an actual scene, which would typically be anything, such as an object or an environment that has been manufactured or is naturally occurring. More particularly, an image is obtained based on light reflecting from an actual scene, typically focused through a lens onto some imaging medium such as a digital capture device or photographic film (which can then be converted into a digital representation).

A configuration application 104 interoperates with a configuration engine 106 via a network 108 such as the internet. In one example, the configuration application 104 is executing on a client computer, although the configuration application may be provided as software as a service (SaaS) and accessible such as using a browser, or the configuration application may be some combination of being executed on a client computer and as SaaS.

A user of the configuration application 104 causes configuration indications (such as parameters, etc., examples of which will be described in detail later) to be provided to the configuration engine 106. A representation (which typically is, but need not be, a low resolution representation) of an “adjusted” image is provided from the configuration engine 106 to the configuration application 104. The small format representation is a representation of what results, or would result, if one or more of the high-resolution, large format, digital representations, in the data store 102, is adjusted in view of the configuration indications provided from the configuration application 104 to the configuration engine 106.

A customer data store 110 is provided to store a high-resolution large-format representation that actually results from the one or more of the high-resolution data files in the data store 102 being adjusted by the configuration engine 106 in view of the configuration indications provided from the configuration application 104 to the configuration engine 106.

In addition, an ordering engine 112 may be provided. The configuration application 104 may interact with the ordering engine 112 to accomplish ordering, from a vendor/fabricator, an object that is produced in view of a high-resolution, large format, representation stored in the customer data store 110. The objects ordered may include, for example, objects used in architecture or in permanent or semi-permanent displays, having the image represented in the high-resolution, large format, representation imbued therein such as infused by a process described in U.S. Pat. No. 6,814,831. The process described in U.S. Pat. No. 6,814,831 is provided as an example and is by no means meant to be construed as an exclusive or limiting statement as to what the objects ordered may be.

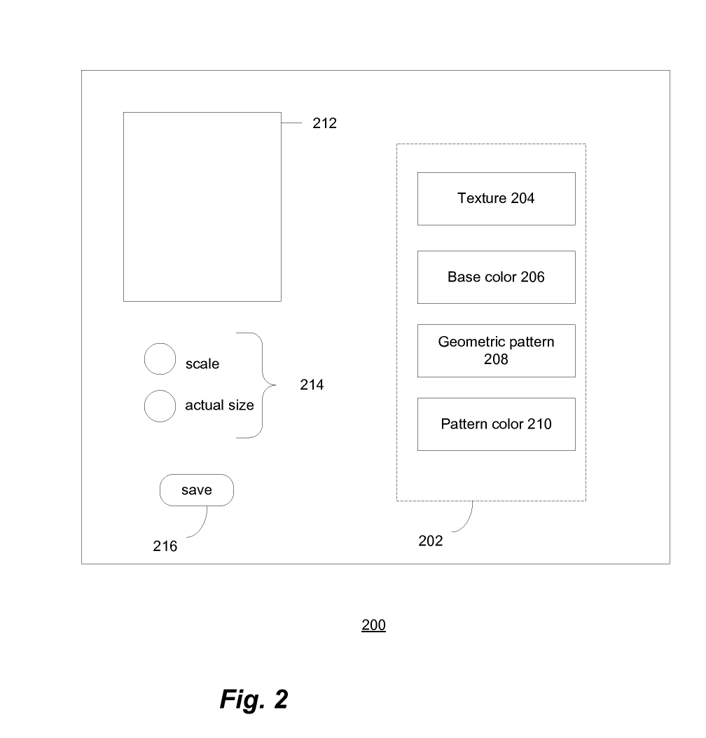

FIG. 2 schematically illustrates an example of a user interface 200 of a configuration application such as the configuration application 104 in FIG. 1. A portion 202 of the user interface 200 provides a configuration area 202 via which the user can cause various types of configuration indications to be provided from the configuration application to the configuration engine. In the FIG. 2 example, the configuration area 202 includes a sub-area 204 via which the user can cause texture configuration indications to be provided from the configuration application to the configuration engine. In one example, the texture indications generally correspond to an actual scene represented by a high-resolution digital representation.

The configuration area 202 further includes a sub-area 206 via which the user can cause color configuration indications for a base color to be provided from the configuration application to the configuration engine; a sub-area 208 via which the user can cause geometric pattern indications to be provided from the configuration application to the configuration engine; and a sub-area 210 via which the user can cause pattern color indications to be provided from the configuration application to the configuration engine. In general, these configuration indications will result in data manipulations to, as opposed to a choice of, a particular high-resolution data file in the data store 102. FIG. 2 is illustrative only; in other examples, the user interface may provide sub-areas via which other types of configuration indications may be caused to be provided from the configuration application to the configuration engine.

The example user interface 200 further includes a display portion 212 in which a small format representation of the adjusted image is displayed, whether based on information provided from the configuration engine 106 to the configuration application 104 or whether generated without involvement of the configuration engine, such as being generated locally as part of client-based tools (e.g., as an integral part of a client-based program, as a browser plug-in or downloadable script, widget or otherwise). Furthermore, a pair of radio buttons 214 provides a facility via which a user can cause a switch between the small format representation being displayed in the display portion 212 and a zoomed-in actual-size representation of a portion of the adjusted image. In other examples, the small format representation may be displayed with various amounts of scaling.

Also in the user interface 200, a “save” button 216 is provided. By activating the save button 216, a signal is provided to cause a rendered large format file, having the current configuration, to be saved. For example, the signal may be provided to the FIG. 1 configuration engine 106 to cause a rendered high-resolution large format digital representation to be saved in the customer file data store 110. In some examples, a “formula” (e.g., a raw or processed list of the configuration parameters) for generating the rendered high-resolution large format digital representation may be saved, without actually generating and saving the rendered high-resolution large format digital representation itself.

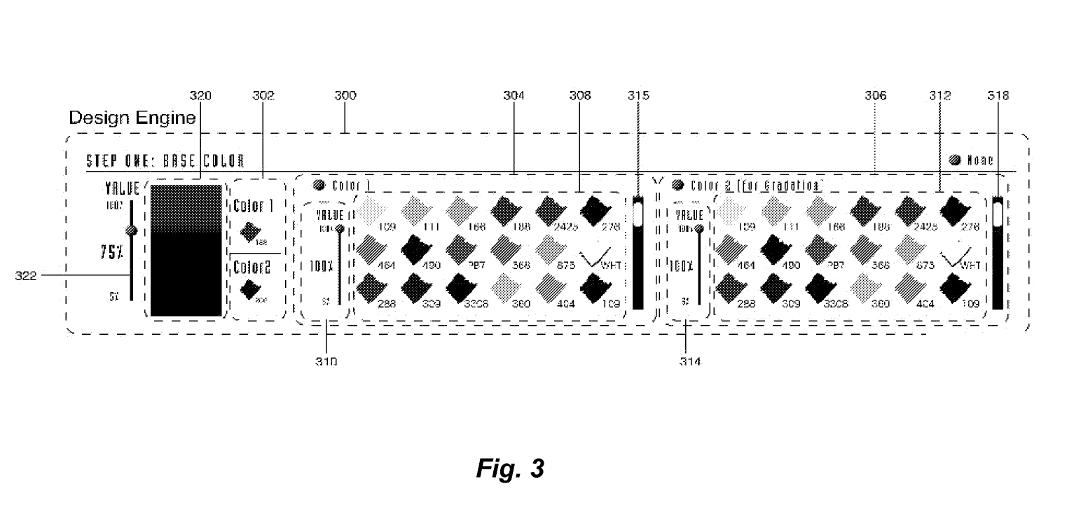

FIG. 3 illustrates, in greater detail, an example 300 of the base color definition portion 206 of the user interface 200 of a configuration application. The color portion 300 is for selecting properties of a base color configuration indication. In the FIG. 3 illustration, it can be seen, for example, that the example color portion 300 includes a portion 302 via which a user can select whether to work with a first color subportion 304 or a second color subportion 306. Thus, for example, to work with the first color subportion 302, the user selects the “Color 1” button; and to work with the second color subportion 304, the user selects the “Color 2” button.

Selecting the “Color 1” button, the first color subportion 304 is activated, and the user can then select a color from the palette 308 and also use the slider bar 310 (or type in a number) to choose a density value of that selected color. If the “Color 2” button is not selected, then the color preview panel 312 will show the selected “Color 1” color as solid. If the “Color 2” button is selected, then the second color subportion 306 is activated, and the user can select a color (using the palette 312) and value (using the slider bar 314) to select a color gradation. In addition, slider bars 316 and 318 can be used to scroll the colors in the palette of the first color subportion 304 and the second color subportion 306, respectively. The resulting chosen base color (or colors) is displayed in the step panel 320 at a level of zoom as controlled by a slider bar 322.

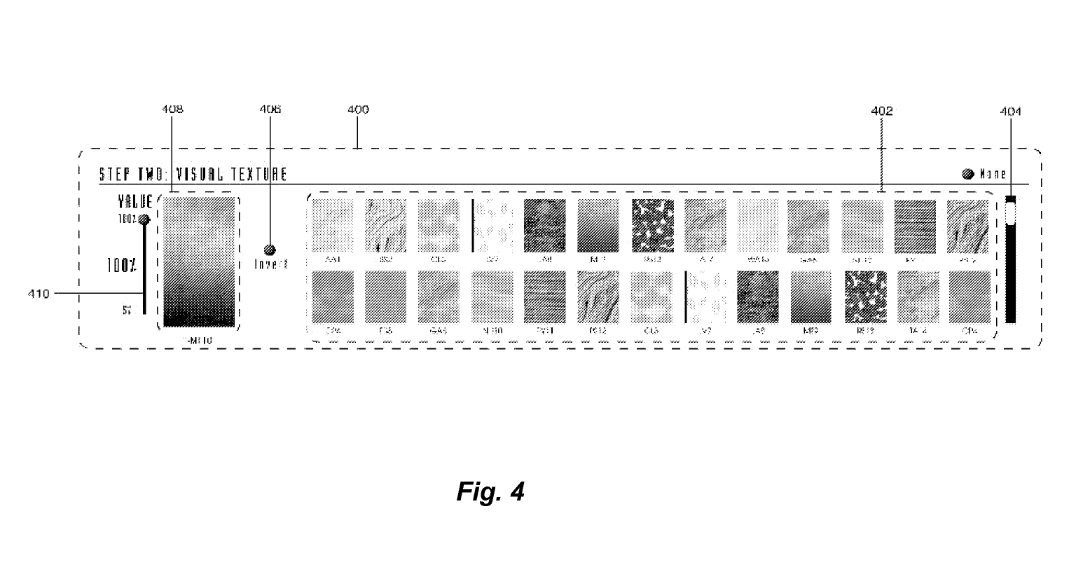

FIG. 4 illustrates, in greater detail, an example 400 of the texture portion 204 of the user interface 200 of a configuration application. In the FIG. 4 illustration, a texture palette 402 is provided, for a user to select one of the textures. In addition, a slider 404 is provided to scroll the texture palette 402. At least some of the textures of the texture palette 402 correspond to high-resolution digital representations such as in the FIG. 1 data store 102. The displayed images of the texture palette 402 may be stepped up (zoomed) to show more detail in the palette. An invert selector 406 allows the user to select to reverse the selected texture. The resulting selected texture is displayed in a step panel 408 at a level of zoom as controlled by a slider bar 410.

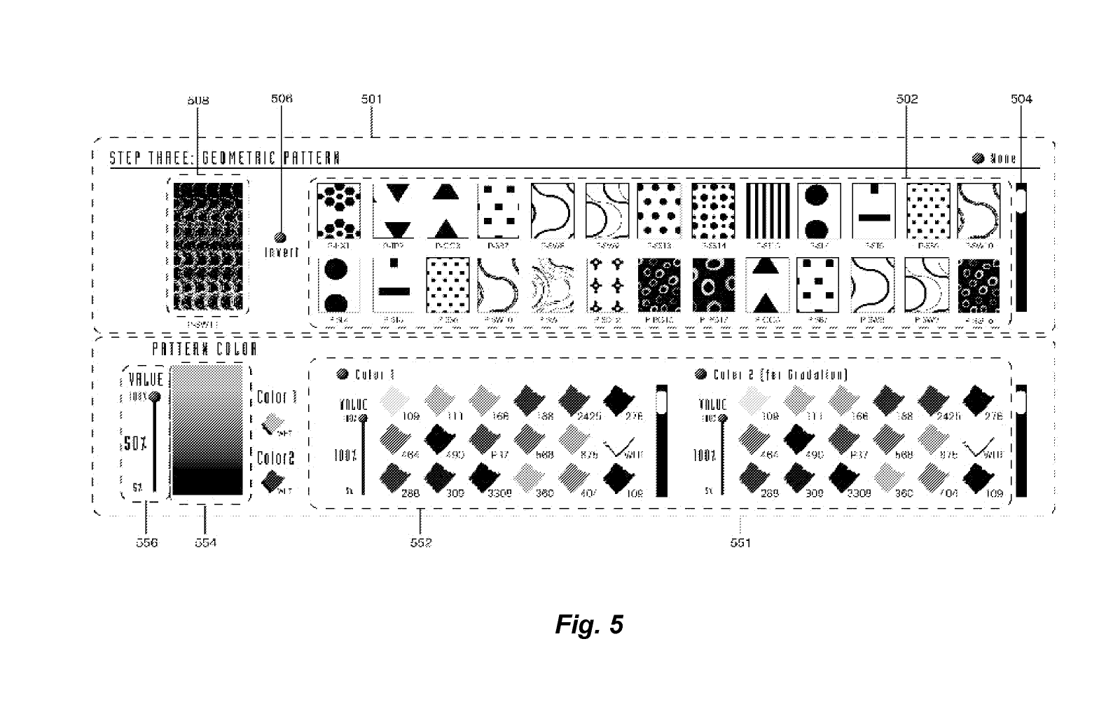

FIG. 5 illustrates examples of the geometric pattern portion 208 (501 in FIG. 5) and the pattern color portion 210 (551 in FIG. 5) of the user interface 200 of a configuration application. A user may interact with the geometric pattern portion 501 to configure a geometric pattern that is, typically, not derived from an image of an actual scene. The palette 502, slider 504, invert selector 406 and step panel 508 are similar to, in FIG. 4, the palette 402, slider 404, invert selector 406 and step panel 408. As a result, the geometric pattern portion 501 is not discussed here in detail.

Turning now to the pattern color portion 551, a user may interact with the pattern color portion 551 to configure a color for the geometric pattern configured using the geometric pattern portion 501. The pattern color definition portion 552 is similar to, in FIG. 3, the first color subportion 304 and the second color subportion 306, collectively, of the example base color portion 300 in FIG. 3. As a result, the pattern color definition portion 552 is not discussed here in detail.

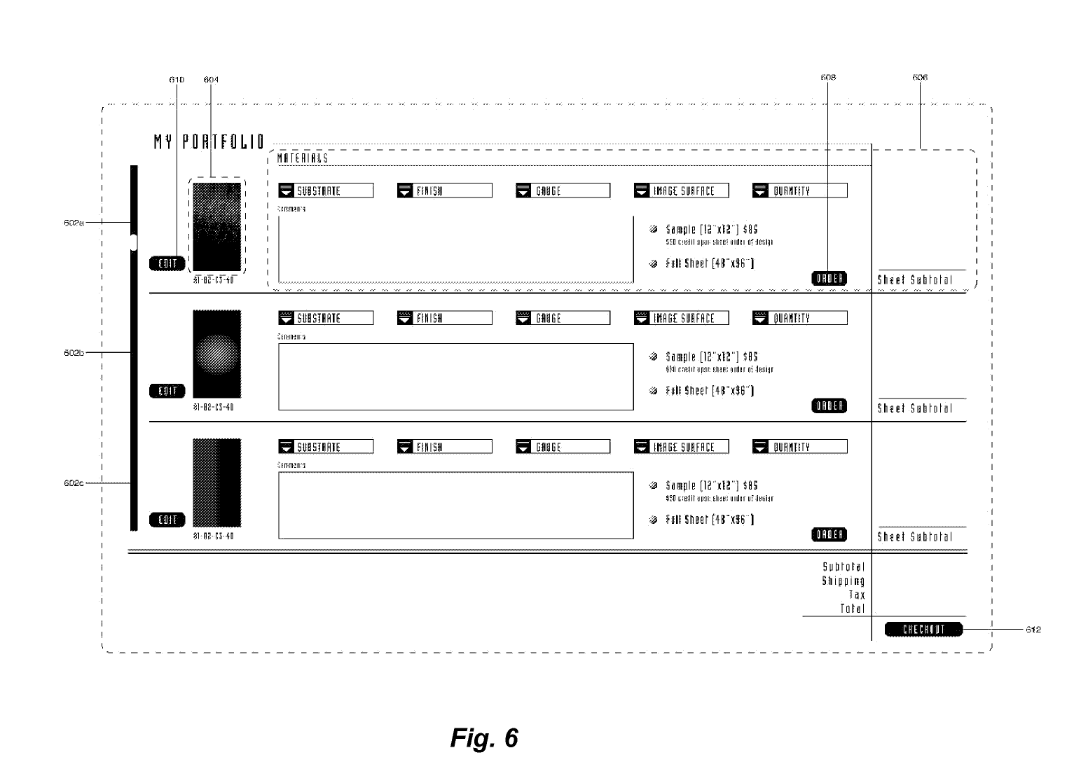

Having described a configuration application and its interface to a configuration engine, we now describe, with reference to FIG. 6, an example user interface to the ordering engine 112 (FIG. 1). Referring to FIG. 6, an example user interface 600 includes a plurality of subportions (602, generically). In the FIG. 6 example, there are three subportions 602a, 602b and 602c. Each subportion 602 may be used to order particular material based on a rendered large format high resolution digital representation, rendered by the configuration engine 106 (FIG. 1) in view of the configuration indications provided from the configuration application 104 to the configuration engine 106.

Taking subportion 602a as an example, a small format version of the rendered large format, high-resolution, digital representation is displayed in the step panel 604. In a materials portion, a user may configure various parameters of the order with respect to a material to be ordered using the resulting high-resolution representation whose small format version is displayed in the step panel 604. In the FIG. 6 example, the various parameters include “substrate,” “finish,” “gauge,” “image surface” and “quantity.” In addition, a sample may be ordered via this subportion 602a, as well as a full sheet. The subportion 602a has an area to enter “comments” (which may be, for example, to indicate special desires or instructions to a vendor). Furthermore, a button 610 is provided that, when activated, causes the configuration application user interface 200 to be displayed, for the user to modify the configuration indications to the rendering engine, to reconfigure the rendering of the large format, high resolution, representation.

By employing the plurality of subportions 602 to generate suborders, an overall order may be generated that is a composite of the suborders configured suing the various subportions 602. By activating the “checkout” button, a payment user interface (not shown) is provided.

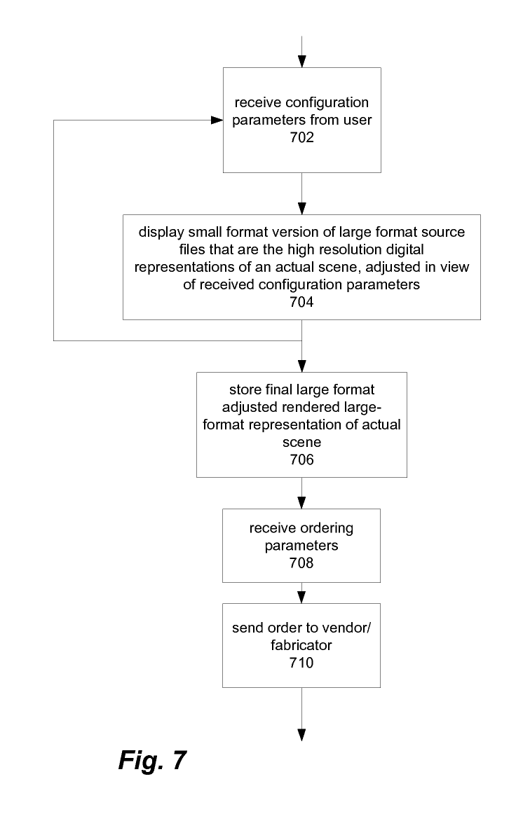

We now discuss, with reference to the flowchart of FIG. 7, a process to utilize a system, such as the system or systems described above with reference to FIGS. 1-6, to achieve an adjusted high-resolution digital representation of an actual scene. At step 702, configuration parameters are received. Such configuration parameters are typically caused to be provided by a user interacting with a configuration application user interface. At step 704, a small format image is displayed. The displayed small format image is a small-format version of a high resolution digital representation of an actual scene as the high resolution digital representation would appear if adjusted in view of the received configuration parameters.

Steps 702 and 704 are repeated until, presumably, a user is satisfied with the proposed adjustment to the high-resolution digital representation of an actual scene, based on the displayed small format image. At 706, the adjusted high-resolution digital representation of an actual scene is rendered (if not already rendered) and stored. At step 708, ordering parameters are received, with respect to ordering an article that is manufactured using the adjusted high-resolution digital representation of an actual scene. At step 710, the order is provided to a manufacturer/vendor.

It is noted that, the steps may be performed in a different order from that shown in the FIG. 7 flowchart. As just one example, in some alternatives, step 706 may be performed each time configuration parameters are received (i.e., once for each version of the small format image displayed at step 704). In other alternatives, step 706 may be performed fewer times (or even only once), such as, for example, once an indication is received that the user is satisfied with the configuration parameters as exemplified, for example, by the displayed small format image. This is but one illustrative example of the steps being performed in a different order from that shown in the FIG. 7 flowchart.

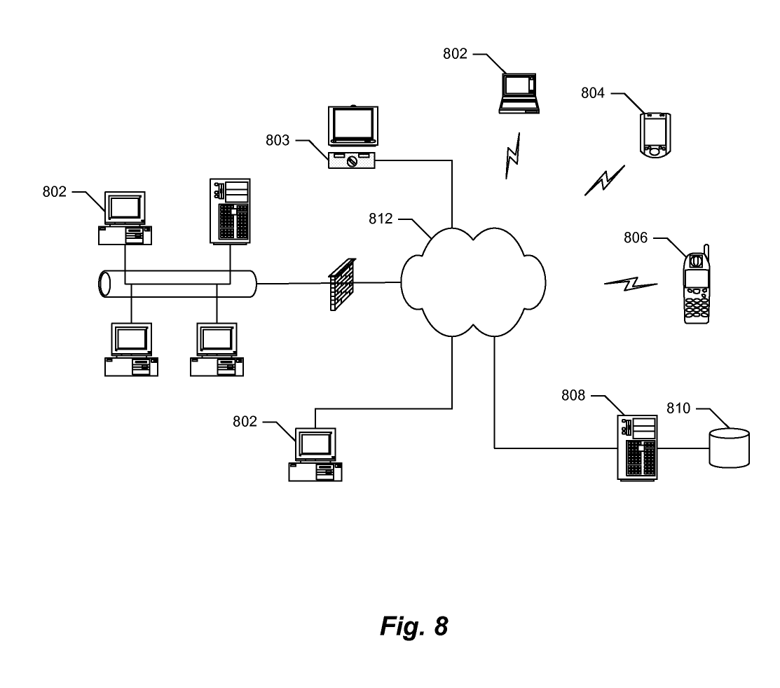

Embodiments may be employed to facilitate enabling custom design of large format output files in any of a wide variety of computing contexts. For example, as illustrated in FIG. 8, implementations are contemplated in which users may interact with a diverse network environment via any type of computer (e.g., desktop, laptop, tablet, etc.) 802, media computing platforms 803 (e.g., cable and satellite set top boxes and digital video recorders), handheld computing devices (e.g., PDAs) 804, cell phones 806, or any other type of computing or communication platform.

According to various embodiments, applications may be executed locally, remotely or a combination of both. The remote aspect is illustrated in FIG. 8 by server 808 and data store 810 which, as will be understood, may correspond to multiple distributed devices and data stores.

The various aspects of the invention may also be practiced in a wide variety of network environments (represented by network 812) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

We have thus described a service via which users can conveniently customize large format digital image files.

What is claimed is:

1. A method of operating a computer-implemented service to generate a high-resolution digital image data file, comprising:
receiving an indication of at least one configuration parameter provided by a user;
causing to be displayed, to the user, a representation of what would result if a high-resolution digital representation of an actual scene is adjusted in view of the at least one configuration parameter; and
generating the high-resolution digital image data file from digital image data that is the high-resolution digital representation of an actual scene, in view of the at least one configuration parameter.

2. The method of claim 1, wherein:
the representation of what would result if a high-resolution digital representation of an actual scene is adjusted in view of the at least one configuration parameter is a low-resolution representation.

3. The method of claim 1, further comprising:
repeating the indication receiving and display causing steps a plurality of times prior to the step of generating the high-resolution digital image data file.

4. The method of claim 1, wherein:
the configuration parameters include parameters for at least one of visual texture, color and geometric pattern.

5. The method of claim 1, further comprising:
selecting the high-resolution digital representation of an actual scene from a plurality of high-resolution digital representations of actual scenes, based on a visual texture configuration parameter received from the user.

6. The method of claim 1, wherein:
the indication of at least one configuration parameter provided by a user is received via a user interface caused to be displayed to the user.

7. The method of claim 1, further comprising:
providing unlimited rights in the generated high-resolution digital image data file.

8. The method of claim 1, further comprising:
creating material based on a rendering of the generated high-resolution digital image data file.

9. The method of claim 1, further comprising:
creating material having an image imbued therein that is a rendering of the generated high-resolution digital image data file.

10. The method of claim 1, further comprising:
receiving a specification of material to be created using the generated high-resolution digital image data file, including a specification of the substrate of the material.

11. The method of claim 10, wherein:
the specification of the substrate of the material includes a type of substrate and at least one of finish, gauge, image surface and quantity of the substrate.

12. The method of claim 1, further comprising:
providing an order to a vendor to create material based on a rendering of the generated high-resolution digital image data file.

13. A method of operating a computer-implemented service to generate a high-resolution digital image data file, comprising:
receiving an indication of at least one configuration parameter provided by a user;
causing to be displayed, to the user, a representation of what would result if a high-resolution digital representation of an actual scene is adjusted in view of the at least one configuration parameter; and
providing the indication of the at least one configuration parameter to an image generation service;
at the image generation service, storing the at least one configuration parameter, wherein the at least one configuration parameter is accessible to use in generating the high-resolution digital image data file from digital image data that is the high-resolution digital representation of an actual scene, in view of the at least one configuration parameter.

14. The method of claim 13, wherein:
the representation of what would result if a high-resolution digital representation of an actual scene is adjusted in view of the at least one configuration parameter is a low resolution representation.

15. The method of claim 13, wherein:
storing the at least one configuration parameter includes storing the at least one configuration parameter in association with an indication of the user.

16. A system to accomplish generation of a high-resolution digital image data file, the system comprising:
a client computing device configured to:
receive an indication of at least one configuration parameter provided by a user;
cause to be displayed, to the user, a representation of what would result if a high-resolution digital representation of an actual scene is adjusted in view of the at least one configuration parameter; and
provide the indication of the at least one configuration parameter, via a network, to an image generation service;
at the image generation service, storing the at least one configuration parameter, wherein the at least one configuration parameter is accessible to use in generating the high-resolution digital image data file from digital image data that is the high-resolution digital representation of an actual scene, in view of the at least one configuration parameter.

17. The system of claim 16, wherein:
storing the at least one configuration parameter includes storing the at least one configuration parameter in association with an indication of the user.

18. The system of claim 16, wherein:
the image generation service is further configured to generate the high-resolution digital image data file from digital image data that is the high-resolution digital representation of an actual scene, in view of the at least one configuration parameter.

19. The system of claim 18, wherein:
the image generation service is further configured to provide an order to a vendor to create material based on a rendering of the generated high-resolution digital image data file.
